(19) United States
(12) Patent Application Publication
(10) Pub. No.: US 2020/0287362 A1
(43) Pub. Date: Sep. 10, 2020

(54) SWITCHGEAR

(71) Applicant: LSIS CO., LTD., Anyang-si (KR)

(72) Inventor: Jun Yeon JO, Anyang-si (KR)

(21) Appl. No.: 16/573,208

(22) Filed: Sep. 17, 2019

(30) Foreign Application Priority Data
Mar. 6, 2019 (KR) 10-2019-0025793

(51) Int. Cl. H02B 11/133; H02B 1/38

(52) U.S. Cl. CPC H02B 11/133; H02B 1/38

(57) ABSTRACT

The present disclosure discloses a switchgear including a housing, a door, a circuit breaker main body, a transfer part, and an interlock device. Here, a front side of the housing is opened to form an external appearance thereof. In addition, the door is hinge-coupled to the front side of the housing to open and close the front side of the housing. The circuit breaker main body is disposed inside the housing to be movable forward and rearward. The transfer part is disposed between the housing and the circuit breaker main body to move the circuit breaker main body. The interlock device restricts the driving of the transfer part when the door is opened.

### CROSS-REFERENCE TO RELATED APPLICATION

Pursuant to 35 U.S.C. § 119(a), this application claims the benefit of earlier filing date and right of priority to Korean Patent Application No. 2019-0025793, filed on Mar. 6, 2019, the disclosure of which is incorporated herein by reference in its entirety.

### BACKGROUND

### 1. Field of the Invention

The present disclosure relates to a switchgear including an interlock device for a vacuum circuit breaker, which has an improved structure.

### 2. Discussion of Related Art

In an industrial site such as a power plant or a substation, a switchgear is installed for various purposes such as operation or control of electric power, operation of an electric motor, and the like, and various electronic devices including a circuit breaker may be disposed inside the above-mentioned switchgear.

Here, a vacuum circuit breaker is a kind of circuit breaker that is installed in a high voltage power system and configured to protect the electrical power system by interrupting a circuit when dangerous situations such as a short circuit or over current occur, and such a vacuum circuit breaker is designed employing properties such as excellent insulation performance and arc extinction capability in a vacuum state.

In addition to the function of accommodating components, the switchgear accommodating the vacuum circuit breaker should have a function to ensure safety when an accident occurs, and thus, except for special cases, in a state in which a door of the switchgear is opened, an insertion or withdrawal of the vacuum circuit breaker should not be permitted.

Therefore, the switchgear includes an interlock device for the vacuum circuit breaker.

FIG. 1 is a perspective view of a conventional switchgear, and FIG. 2 is a view illustrating a conventional interlock device.

Referring to FIGS. 1 and 2, a switchgear 10 is a cabinet 11 of a substantially regular hexahedron having an opened front side, and a door 12 is hinge-fastened to one side of the cabinet to open and close the front side of the switchgear 10.

A vacuum circuit breaker may be movably disposed inside the switchgear 10, and the vacuum circuit breaker may include a circuit breaker main body 13 and a transfer part 14.

The transfer part 14 includes a structure disposed below the circuit breaker main body 13 to move the circuit breaker main body 13 forward and rearward in the switchgear 10.

Specifically, the transfer part 14 includes a carriage 15 disposed below the circuit breaker main body 13 and a lead screw 16 configured to move the carriage 15. In addition, the lead screw 16 is forwardly or reversely rotated by manipulation of a manipulating handle 1 (see FIG. 3) entering the switchgear 10 from the outside of the door 12 to move the circuit breaker main body 13 forward or rearward.

In a general state, an angular rotation preventing part is disposed on an outer circumferential surface of the lead screw 16, and the lead screw is disposed such that the rotation preventing part is inserted into a rotation preventing groove formed at a push block 19, and thus rotation of the lead screw is limited.

In addition, the push block 19 should be moved rearward to be spaced apart from the rotation preventing groove, and this movement is restricted by supporting a rear side of the push block 19 using an interlock protrusion 17a of an interlock device 17.

In this state, in order to rotate the lead screw 16, a safety structure must be released in two stages.

Firstly, a lever 18 disposed on an inner side surface of the door 12 in a protruding manner should enter the interlock device 17 disposed above the push block 19, and the interlock protrusion 17a in the interlock device 17 is thus moved upward to be spaced apart from the push block 19.

Secondly, when the manipulating handle 1 enters from the outside of the door 12 into the insider, is inserted into a front portion of the lead screw 16, and then presses the lead screw rearward, the push block 19 which fixes the lead screw 16 is pushed rearward, and as a result, the push block is spaced apart from the lead screw 16.

The conventional switchgear 10 has the following problems.

As described above, in order to rotate the lead screw 16, the lever 18 should first be inserted into the interlock device 17, and thus problems may occur depending on an arrangement of the door 12.

In other words, when the door 12 is hinge-fastened to one side of the switchgear 10, if a hinge point is distorted over time due to misalignment or weight of the door 12, the lever 18 may not be smoothly inserted into the interlock device 17. Therefore, a free end of the conventional lever 18 is taper-machined to allow the lever to smoothly enter the inside of the interlock device 17. In this case, however, since the lever 18 is generally made of a metal material and a housing of the interlock device 17 is formed of a plastic material, there is a problem that the interlock device 17 may be damaged.

### SUMMARY OF THE INVENTION

The present disclosure has been made to solve the above problems, and the present disclosure is to providing a switchgear including an interlock device for a vacuum circuit breaker, which has improved durability and is less affected by a coupling state of a door.

In order to achieve the above object, the present disclosure provides a switchgear including: a housing having an opened front side and forming an external appearance; a door hinge-coupled to the front side of the housing to open or close the front side of the housing; a circuit breaker main body disposed inside the housing to be movable forward and rearward; a transfer part disposed between the housing and the circuit breaker main body to move the circuit breaker main body; and an interlock device configured to restrict the driving of the transfer part when the door is opened

The transfer part may include: a fixed frame fastened to the housing; a lead screw disposed on the fixed frame to receive a rotational force from a manipulating handle configured to enter the housing from the outside of the door and fastened to one end arranged at the front side; a carriage configured to support the circuit breaker main body and moved by the lead screw; and a push block fastened to the lead screw in an original state to restrict the rotation of the lead screw and moved rearward when the manipulating handle is fastened thereto to release the fastening with the lead screw.

The lead screw may be provided with a nut-shaped rotation preventing protrusion disposed on an outer circumferential surface thereof, and the push block may be provided with a rotation preventing groove having a shape corresponding to that of the rotation preventing protrusion.

The interlock device may restrict the rearward movement of the push block when the door is opened.

The interlock device may include: a body fixed to the fixed frame and provided with a front hole and a lower hole; a movement preventing body movably disposed inside the body, the movement preventing body being configured to protrude outward from the lower hole of the body to come into contact with a rear side surface of the push block in its original state, and to enter the lower hole of the body to be spaced from the rear side surface of the push block in a moved state; an elastic body having one end disposed on the body and the other end disposed on the movement preventing body to provide a returning force such that the movement preventing member is moved to its original state; a button disposed inside the body such that one end thereof is in contact with the movement preventing body and having the other end protruding to the outside of the front hole of the body when the movement preventing body is in its original position; and a pressing protrusion disposed on an inner side surface of the door corresponding to the button, to press the button when the door is closed.

One side surface of the movement preventing body may be rounded, and one end of the button which is in contact with the movement preventing body may have an inclined shape to be inserted between one side surface of the movement preventing body and a lower side surface of the body.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view of a conventional switchgear;

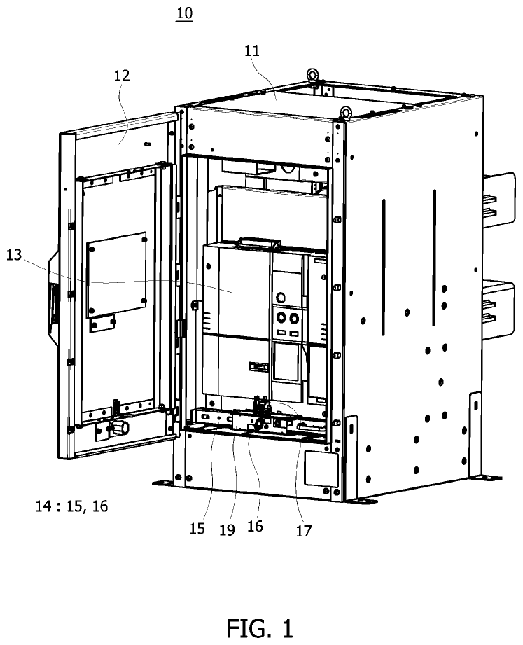

FIG. 2 is a view illustrating a conventional interlock device;

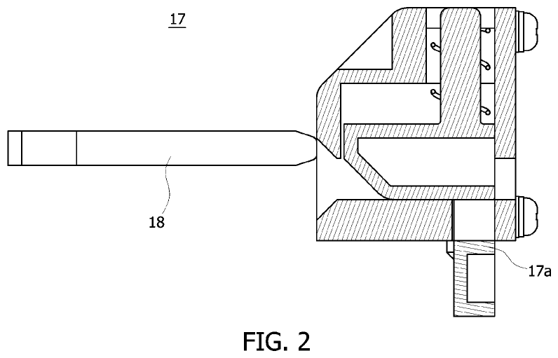

FIG. 3 is a partial side sectional view of a switchgear according to an embodiment of the present disclosure in which an interlock device for a vacuum circuit breaker is disposed;

FIG. 4 is an enlarged view of the inside of the switchgear in FIG. 3 when a door is closed;

FIG. 5 is a perspective view of the interlock device for a vacuum circuit breaker of the switchgear according to an embodiment of the present disclosure; and

FIG. 6 is a side sectional view of FIG. 5.

### DETAILED DESCRIPTION OF EXEMPLARY EMBODIMENTS

Hereinafter, preferred embodiments of the present disclosure will be described in detail below with reference to the accompanying drawings. While the present disclosure is shown and described in connection with exemplary embodiments thereof, it will be apparent to those skilled in the art that various modifications can be made without departing from the spirit and scope of the disclosure.

Unless otherwise defined, all terms used herein have the same meaning as the general meaning of terms understood by one of ordinary skill in the art, and if the terms used herein conflict with a general meaning of terms used in the art, these terms will be employed according to a definition prescribed herein.

However, the disclosure to be described below is not intended to limit the scope of the present disclosure, but to describe embodiments of the present disclosure, and the same reference numerals throughout the specification represent the same components.

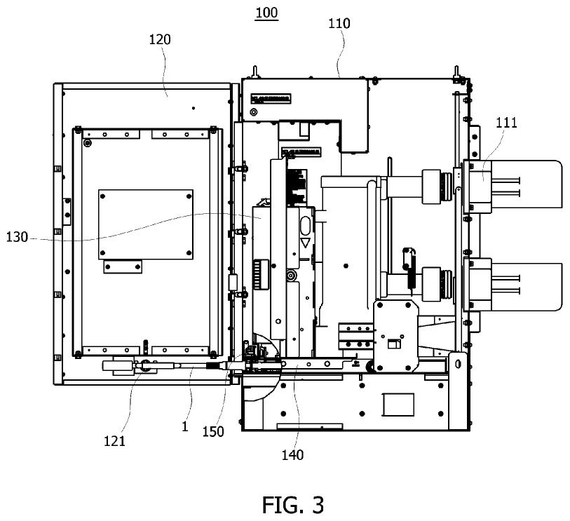

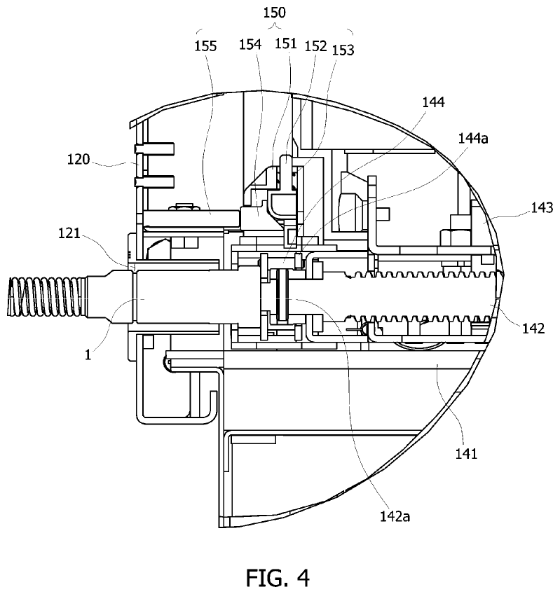

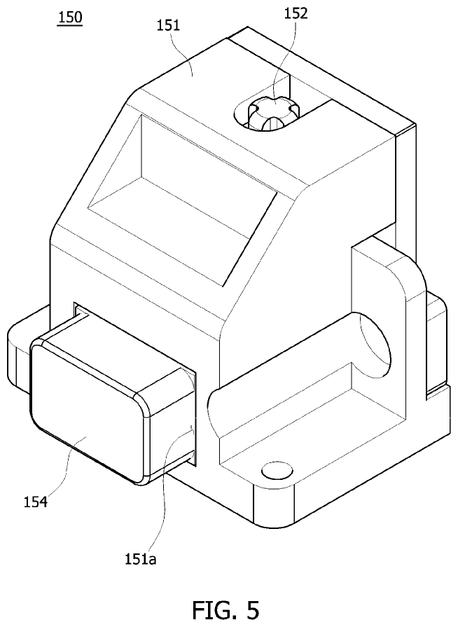

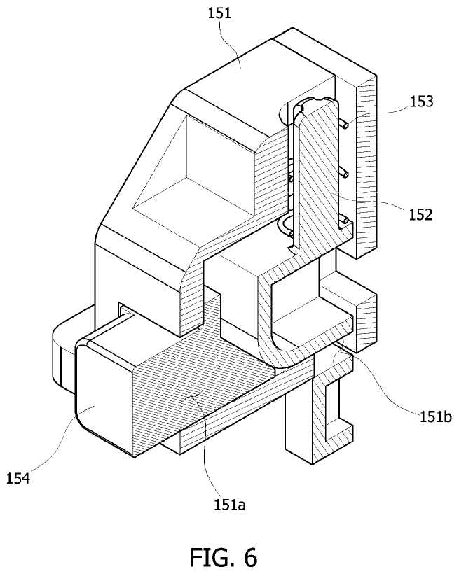

FIG. 3 is a partial side sectional view of a switchgear according to an embodiment of the present disclosure in which an interlock device for a vacuum circuit breaker is disposed, FIG. 4 is an enlarged view of the inside of the switchgear in FIG. 3 when a door is closed, FIG. 5 is a perspective view of the interlock device for a vacuum circuit breaker of the switchgear according to an embodiment of the present disclosure, and FIG. 6 is a side sectional view of FIG. 5.

Referring to FIGS. 3 to 6, a switchgear 100 according to an embodiment of the present disclosure may largely include a housing 110, a door 120, a circuit breaker main body 130, a transfer part 140, and an interlock device 150.

The housing 110 has an opened front side to form an external appearance of the switchgear 100, and may be formed in the shape of a substantially rectangular parallelepiped or regular hexahedron.

The circuit breaker main body 130, the transfer part 140, and the interlock device 150, which are described later, may be accommodated in the above-described housing 110, and other components constituting the switchgear 100 may be accommodated in the housing.

The door 120 may be hinge-connected to the front side of the housing 110 to open and close the front side of the housing 110.

In addition, a pressing protrusion 155 that is described later may be fastened to an inner side surface of the door 120 to correspond to a location of a button 154 that is described later, and an entry hole 121 may be formed in a lower side surface of the door 120. Here, a separate manipulating handle 1 for rotating a lead screw 142 that is described later may be inserted into the entry hole 121.

The circuit breaker main body 130 may be disposed inside the housing 110 to be moved forward and rearward, and may be moved rearward to be electrically coupled to a terminal 111 which may be connected to an external terminal.

The transfer part 140 may constitute a circuit breaker together with the circuit breaker main body 130, and may be disposed between the housing 110 and the circuit breaker main body 130 to move the circuit breaker main body 130 forward and rearward.

Here, the term “forward” means a direction directed towards the door 120, and the term “rearward” may mean a direction directed towards a sidewall, at which the terminal 111 is disposed, which is opposite to the door 120, in the housing 110. The transfer part 140 is provided for moving the circuit breaker main body 130, as described above, and may include a fixed frame 141, the lead screw 142, a carriage 143, and a push block 144.

The fixed frame 141 supports a lower side of the circuit breaker main body 130, and may be fastened and fixed to the housing 110.

The lead screw 142 may be disposed in the fixed frame 141 to receive a rotational force from the manipulating handle 1, which enters the housing from the outside of the door 120 and is fastened to one end of the lead screw arranged at a front side of the housing.

The carriage 143 is disposed on the fixed frame 141 to support the circuit breaker main body 130, and may be moved by the lead screw 142 to move the circuit breaker main body 130.

The push block 144 is provided to prevent the inadvertent rotation of the lead screw 142, and fastened to the lead screw 142 in an original state to limit the rotation of the lead screw 142. When the manipulating handle 1 is fastened thereto, the push block 144 may be moved rearward to release the fastening with the lead screw 142 and the push block.

Specifically, a nut-shaped rotation preventing protrusion 142a is disposed on an outer circumferential surface of the lead screw 142. In addition, the push block 144 may be formed with a rotation preventing groove 144a having a shape corresponding to that of the rotation preventing protrusion 142a.

Under such a configuration, in a state that is not pressed by the manipulating handle 1, the push block 144 is disposed at the front side to allow the rotation preventing groove 144a to come into contact with an outer side surface of the rotation preventing protrusion 142a or to be spaced from the rotation preventing protrusion by a certain distance, and thus it is possible to restrict the rotation of the lead screw 142.

When the manipulating handle 1 enters the housing through the door 120 and is fastened to a front portion of the lead screw 142 and then pressed, the push block 144 is moved rearward by a pressing force of the manipulating handle 1, and as a result, the lead screw 142 may be in a rotatable state.

However, the interlock device 150 according to the embodiment of the present disclosure restricts the rearward movement of the push block 144 when the door 120 is opened, and thus it is possible to further improve the stability of the switchgear 100 according to an embodiment of the present disclosure.

Specifically, the interlock device 150 may include a body 151, a movement preventing body 152, an elastic body 153, the button 154, and the pressing protrusion 155.

The body 151 is fixed to the fixed frame 141 and may have a front hole 151a and a lower hole 151b formed therein. Such the body 151 may be directly fixed to the fixed frame 141 or fixed to the fixed frame via a separate bracket.

Referring to FIGS. 4 to 6, the movement preventing body 152 is movably disposed inside the body 151. However, the movement preventing body 152 may be configured to protrude outward from the lower hole 151b of the body 151 to come into contact with a rear side surface of the push block 144 in its original state, and to enter the lower hole 151b of the body to be spaced from the rear side surface of the push block 144 in a moved state.

In other words, the movement preventing body 152 may be moved in one direction (an upward direction in the drawing) inside the body 151 when an external force is applied from a device such as a cylinder.

One end of the elastic body 153 is disposed on the body 151 and the other end is disposed on the movement preventing body 152 to provide a returning force to allow the movement preventing body 152 to be moved to its original state. A coil spring accommodating the movement preventing body 152 may be employed as the elastic body 153.

The button 154 is disposed inside the body 151 so that one end thereof is in contact with the movement preventing body 152, and the other end of the button may protrude to the outside of the front hole 151a of the body 151 when the movement preventing body 152 is in its original position.

Due to the above-described button 154, the pressing protrusion 155 that is described later does not enter the body 151 so that durability of the interlock device 150 according to an embodiment of the present disclosure can be enhanced.

In addition, in consideration of the functions of the button 154 and the movement preventing body 152, one side surface of the movement preventing body 152 is formed to be rounded, and one end of the button 154 which is in contact with the movement preventing body 152 may have an inclined shape to be inserted between one side surface of the movement preventing body 152 and a lower side surface of the body 151 when the door 120 is closed.

The pressing protrusion 155 may be disposed on an inner side surface of the door 120 corresponding to the button 154, to press the button 154 when the door 120 is closed.

In addition, in order for the pressing protrusion 155 to effectively press the button 154, a cutting surface of the pressing protrusion 155 may be formed to have an area smaller than or equal to that of a cutting surface of the button 154.

In addition, in order for the pressing protrusion 155 to effectively press the button 154, a free end of the pressing protrusion 155 may protrude or may be recessed in a curved shape, and a free end of the button 154 may be recessed or may protrude in a curved shape.

In short, in the switchgear 100 according to the present disclosure, the structure of the interlock device 150 is improved to ensure accurate operation of the interlock device 150 regardless of a fastening precision of the door 120 with respect to the switchgear 100. In addition, there is an advantage in that since the pressing protrusion 155 disposed on the door 120 does not come in contact with the body 151 of the interlock device 150, durability can be improved.

The present disclosure is improved to have the structure in which a pressing protrusion disposed on an inner side surface of a door presses a button protruding to the outside of an interlock device, rather than a structure in which the pressing protrusion does not enter the inside of the interlock device, so that durability of the interlock device is enhanced and it is possible for the interlock device to accurately prevent the rotation of a lead screw.

It will be apparent to those skilled in the art that various modifications and changes can be made to the above-described exemplary embodiments of the present disclosure without departing from the spirit or scope of the disclosure. In addition, the technical scope of the present disclosure should not be limited to the contents described in the embodiments, but should be defined by the appended claims and their equivalents.

What is claimed is:

1. A switchgear comprising:
a housing having an opened front side and forming an external appearance;
a door hinge-coupled to the front side of the housing to open or close the front side of the housing;
a circuit breaker main body disposed inside the housing to be movable forward and rearward;
a transfer part disposed between the housing and the circuit breaker main body to move the circuit breaker main body; and
an interlock device configured to restrict the driving of the transfer part when the door is opened.

2. The switchgear of claim 1, wherein the transfer part comprises:
a fixed frame fastened to the housing;
a lead screw disposed on the fixed frame to receive a rotational force from a manipulating handle configured to enter the housing from the outside of the door and fastened to one end arranged at the front side; and
a carriage configured to support the circuit breaker main body and moved by the lead screw.

3. The switchgear of claim 2, wherein the transfer part further comprises a push block fastened to the lead screw in an original state to restrict the rotation of the lead screw, and moved rearward when the manipulating handle is fastened thereto to release the fastening with the lead screw.

4. The switchgear of claim 3, wherein the lead screw is provided with a nut-shaped rotation preventing protrusion disposed on an outer circumferential surface thereof.

5. The switchgear of claim 4, wherein the push block is provided with a rotation preventing groove having a shape corresponding to that of the rotation preventing protrusion.

6. The switchgear of claim 3, wherein the interlock device restricts the rearward movement of the push block when the door is opened.

7. The switchgear of claim 3, wherein the interlock device comprises:
a body fixed to the fixed frame, and provided with a front hole and a lower hole;
a movement preventing body movably disposed inside the body, the movement preventing body being configured to protrude outward from the lower hole of the body to come into contact with a rear side surface of the push block in its original state, and to enter the lower hole of the body to be spaced from the rear side surface of the push block in a moved state; and
an elastic body having one end disposed on the body and the other end disposed on the movement preventing body, to provide a returning force such that the movement preventing member is moved to its original state.

8. The switchgear of claim 7, wherein the interlock device comprises;
a button disposed inside the body and having one end in contact with the movement preventing body and the other end protruding to the outside of the front hole of the body when the movement preventing body is in its original position; and
a pressing protrusion disposed on an inner side surface of the door corresponding to the button, to press the button when the door is closed.

9. The switchgear of claim 8, wherein one side surface of the movement preventing body is rounded, and one end of the button which is in contact with the movement preventing body has an inclined shape to be inserted between one side surface of the movement preventing body and a lower side surface of the body when the door is closed.
